(19) United States
(12) Patent Application Publication
(10) Pub. No.: US 2008/0204834 A1
(43) Pub. Date: Aug. 28, 2008

(54) Displaying holographic images

(76) Inventor: Philip Nicholas Cuthbertson Hill, Reading (GB)

Correspondence Address: JAMES C. WRAY, 1493 CHAIN BRIDGE ROAD, SUITE 300, MCLEAN, VA, 22101, US

(21) Appl. No.: 12/070,066

(22) Filed: Feb. 14, 2008

(30) Foreign Application Priority Data
Feb. 16, 2007 (GB) 07 02 991.1

(51) Int. Cl. G03H 1/08

(52) U.S. Cl. 359/9; 705/27

(57) ABSTRACT

There is provided a method of displaying a holographic image, the method comprises a number of steps. Three-dimensional object data is manipulated (802) that defines positions in a three-dimensional world space. A plurality of notional viewing locations are identified (803) that are compatible with notional eye-viewable positions. A two-dimensional image data set is produced (803) from the three-dimensional object data for each identified viewing location. The two-dimensional image data sets are processed (804) to produce phase-emphasised holographic data. The phase of a coherent light source is modulated (805) and the coherent light is directed to a viewer so as to be viewable at locations compatible with the eye-viewable locations.

### CROSS REFERENCE TO RELATED APPLICATIONS

This application claims priority from United Kingdom Patent Application No. 07 02 991.1, filed 16 Feb. 2007, the entire disclosure of which is incorporated herein by reference in its entirety.

### TECHNICAL FIELD

The present invention relates to a method of displaying a holographic image and apparatus for displaying a holographic image.

### BACKGROUND OF THE INVENTION

Holography has been known for a number of years and allows images to be generated that represent objects in three dimensions. Furthermore, the images produced tend to be substantially transparent thereby allowing the internal components of an object to be visualised from a number of different angles.

Moving images have been known for a number of years generated by cinematic film or video etc. These systems provide a degree of realism by creating the illusion of a continually moving image from a sequence of snapshots. Procedures have been made to enhance the three-dimensional nature of such images, by relying upon stereoscopic principles. It is also known for data of this type to be generated in computer modelling systems in which two-dimensional renderings are produced from three-dimensional world space data.

### BRIEF SUMMARY OF THE INVENTION

According to an aspect of the present invention, there is provided a method of displaying a holographic image, comprising the steps of: manipulating three-dimensional object data that defines positions in a three-dimensional world space; identifying a plurality of notional viewing locations that are compatible with notional eye-viewable positions; producing a two-dimensional image data set from said three-dimensional object data for each identified viewing location; processing said two-dimensional image data sets to produce phase-emphasised holographic data; modulating the phase of a coherent light source; and directing said coherent light to a viewer so as to be viewable at locations compatible with said eye viewable locations.

In a preferred embodiment, the modulating step is performed in response to the holographic data being applied to an array of phase responsive liquid crystals.

According to a second aspect of the present invention, there is provided an apparatus for displaying a holographic image, comprising a display device having a viewing aperture, a source of coherent light, a spatial phase modulator for modulating said coherent light in response to a control signal, and a processing device for producing said control signal, wherein said processing device is configured to: manipulate three-dimensional image data; identify a plurality of notional viewing locations; produce two-dimensional image data sets; and process said data sets to produce said control signal taking the form of a phase-emphasised holographic control signal.

### BRIEF DESCRIPTION OF THE SEVERAL VIEWS OF THE DRAWINGS

FIG. 1 shows a computer aided design system embodying the present invention;

FIG. 2 details the holographic display device identified in FIG. 1;

FIG. 3 shows a similar view to FIG. 2, where an operator has moved their head to the left;

FIG. 4 shows an illustration of an image displayed following manipulation of data;

FIG. 5 shows a cross-section through display device 107;

FIG. 6 shows detail of light modulating device 502;

FIG. 7 shows an example of differing phase delays;

FIG. 8 shows an overview of procedures according to the present invention;

FIG. 9 shows a representation of identifying a plurality of notional viewing locations;

FIG. 10 shows a representation of sampling the viewing space;

FIG. 11 gives the first example of procedures taking place as part of step 804; and

FIG. 12 gives a second example of procedures taking place as part of step 804.

### DESCRIPTION OF THE BEST MODE FOR CARRYING OUT THE INVENTION

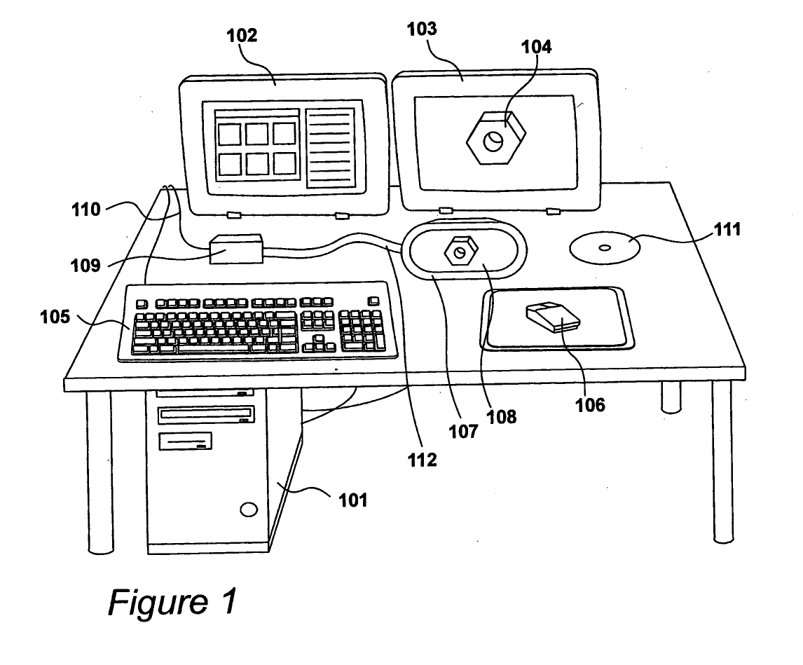

### FIG. 1

A computer aided design system is illustrated in FIG. 1. This represents one of many examples in which use may be made of apparatus for displaying a holographic image. A non-exhaustive list of other applications for the apparatus is detailed below.

The computer aided design system includes a programmable computer 101 having executable instructions loaded thereon to facilitate the creation and display of three-dimensional objects. The computer 101 supplies conventional two-dimensional image data to a first visual display unit 102 and onto a second visual display unit 103. In the example shown, it is possible for menus to be displayed on display unit 102 and a workspace to be displayed on unit 103. In this example, an operator is defining a three-dimensional shape 104 by manual operation of a keyboard 105 and a mouse 106, or alternative manually operable input devices.

As shown on visual display unit 103, the three-dimensional object 104 takes the form of a two-dimensional render. The computer system 101 is provided with a graphics card such that it is possible for two-dimensional scenes to be rendered in real time from three-dimensional data. Thus, manual operation of input devices results in the creation of three-dimensional data but at any one time it is only possible for the operator to perceive a two-dimensional view. In response to manual operation of mouse 106, it is possible for the operator to manipulate the three-dimensional object being created, so as to translate it and rotate it in a perceived three-dimensional environment. However, at any particular instant, the object is only viewed in two-dimensions.

In the environment of FIG. 1, the three-dimensional experience is enhanced by the provision of a holographic display device 107 having a viewing aperture 108. In this example, a holographic acceleration processor 109 is provided although in alternative embodiments, this processor could be included as a card held within computer system 101 or, given sufficient processing power, could be implemented as a program executable on system 101. However, in this embodiment, substantial additional processing capability is provided by the provision of the holographic acceleration processor 109 implemented substantially using hardware programmable gate arrays or similar hardware solutions that facilitate the parallel processing of image data.

The computer system 101 is interfaced with the acceleration processor 109 via a suitable interface cable 110 and before use a DVD or other instruction carrying medium 111 is loaded into computer system 101 so as to install appropriate drivers and software interfaces. Thus, in this way, it is possible for the computer aided design system executed by computer 101 to provide three-dimensional data to the acceleration processor 109.

In response to receiving three-dimensional data the acceleration processor 109 is configured to receive manipulated three-dimensional image data and having received this data the processor identifies a plurality of notional viewing locations from which it is possible to produce two-dimensional image data sets. Thus, whereas the computer aided design system 101 produces a single rendered image to be viewed on display unit 103, the acceleration processor 109 renders many images from a selection of viewing positions. Each of these rendered images is then processed to produce a control signal supplied on interface 112 to the holographic display device 108. This control signal takes the form of a phase-emphasised holographic control signal. In this way, it is possible for an operator to see, via a holographic display device 107, a three-dimensional representation of object 104 in addition to the flat representation shown on VDU 103. These holographic images are also produced in real time such that manipulation of object 104 as previously described not only results in the object appearing to move as viewed on VDU 103 but the object also appears to move in its three-dimensional representation as shown on the holographic display device 107. However, whereas the image shown on VDU 103 appears flat, an operator may move to a different viewing position which will result in a different representation of the object being seen, due to its holographic representation. Thus, the object may be animated in its three-dimensional representation and while being animated its three-dimensional qualities may also be appreciated as different viewing locations are adopted.

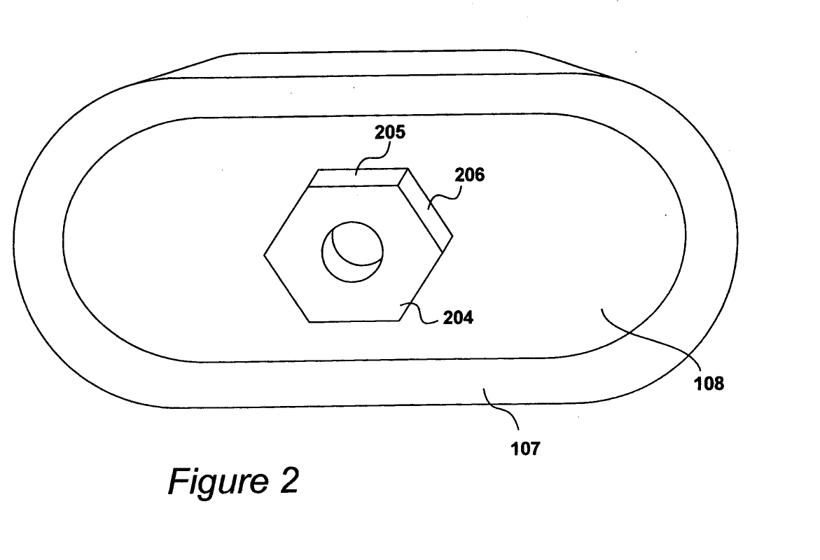

### FIG. 2

The holographic display device 107 identified in FIG. 1 is shown in greater detail in FIG. 2. An operator when viewing into the viewing aperture 108 will see an object 204 substantially similar to object 104 shown on VDU 103 and derived from the same three-dimensional data. In the position shown in FIG. 2, in addition to a front face, an operator will also see an upper face 205 and a right side face 206. These are substantially similar to the surfaces displayed by monitor 103.

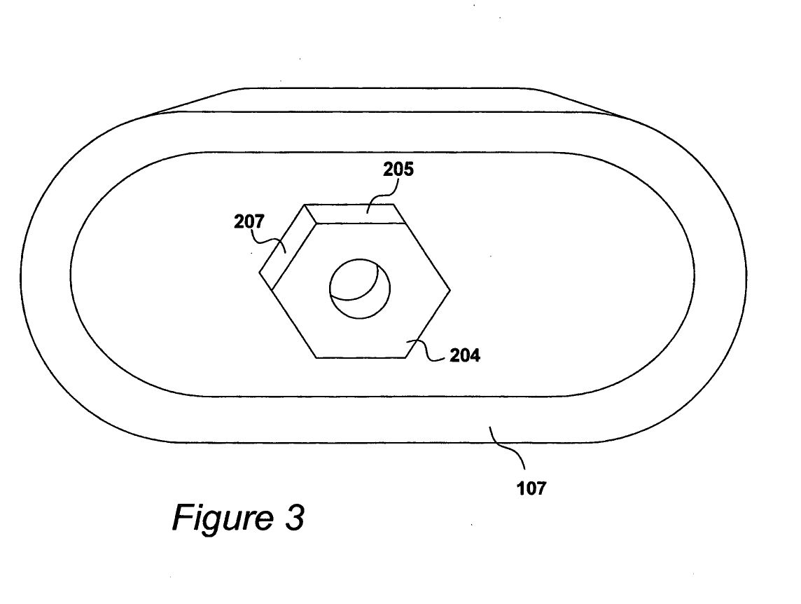

### FIG. 3

The same object 204 is shown displayed on the same display device 103 in FIG. 3. However, on this occasion, an operator has moved their head to the left and therefore the object 204 is now being viewed from a different position. If such a movement is made with respect to VDU 103, the nature of the display remains substantially the same given that display unit 103 shows a flat two-dimensional representation of the object. Display device 107 shows a holographic representation of the three-dimensional object. Thus, with an operator's head moved towards the right it is possible to see the right side of the object, as illustrated in FIG. 2. However, when an operator moves their head to the left, different surfaces of the object are shown. In this example upper surface 205 is shown (although in a different perspective) and left side face 207 is shown, with right side face 206 now being obscured.

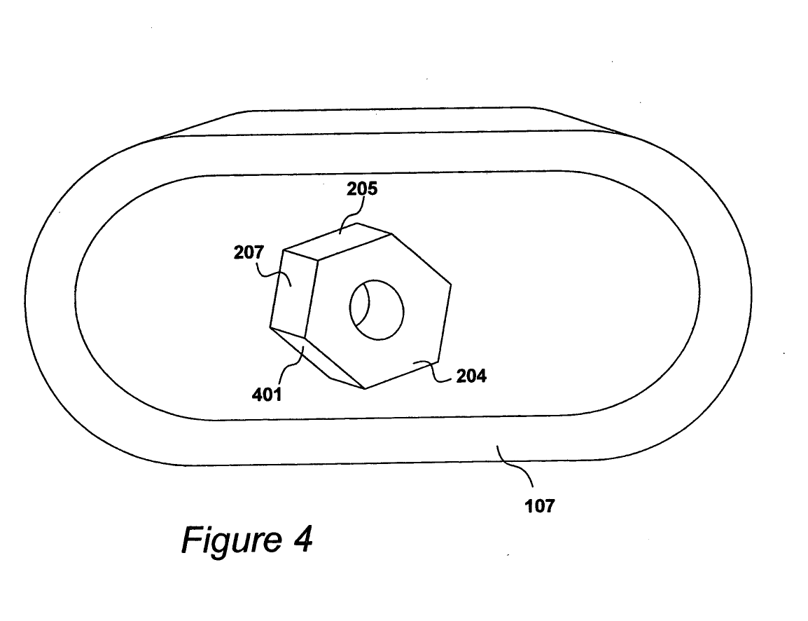

### FIG. 4

In addition to still three-dimensional holographic data being produced, as illustrated with respect to FIGS. 2 and 3, it is also possible for this holographic data to be animated. Furthermore, in an embodiment, revised holographic data is continually produced so as to allow movement of the three-dimensional image. Preferably, the revisions occur substantially at video frame rate (typically 25 or 30 frames per second) in real time to thereby produce naturalistic movement.

Thus, as illustrated in FIG. 4, an operator has provided input data to the system so as to define a rotation of the component about a vertical axis. Thus, as displayed both on monitor 103 and on holographic device 107, object 204 appears to have rotated about a vertical axis. Right face 206 has therefore become obscured, left face 207 is seen in greater detail and a second left face 401 becomes visible. Thus, when viewing holographic device 107, object movements may occur as a result of two different types of procedures being carried out. Firstly, as illustrated with respect to FIG. 4, an object may be animated by manual input for example, resulting in revised data being produced, preferably at video rate. The revisions occurring substantially at video frame rate produces naturalistic movement of the holographic image. In this example, revised holographic data is continually produced to allow movement of the three-dimensional image. In the present embodiment, video rate holographic data is produced in real time, and in an alternative embodiment it is pre-calculated and read from storage. In addition, at any point in time, it is possible for an operator move to a different viewing position and thereby achieve a different holographic effect so as to create the perception of the object being three-dimensional.

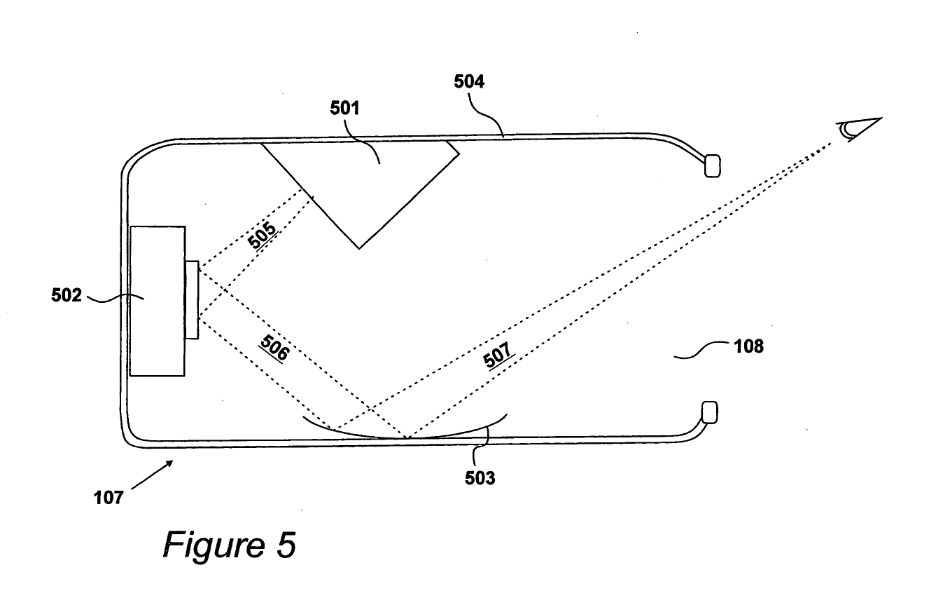

### FIG. 5

A cross-section through display device 107 is shown in FIG. 5. A coherent light source 501 is provided which in this example is a laser. A light modulating device is provided at 502. A reflective device is provided at 503. In this example, light modulating device 502 is an array of phase responsive liquid crystals. In alternative embodiments, any apparatus capable of modulating the phase of a coherent light source can be used. In this example, reflective device 503 is a curved mirror. In alternative embodiments, a lens may be used. Any apparatus which is capable of causing the light to diverge can be used in place of reflective device 503.

Components 501, 502 and 503 are contained within housing 504. A beam of coherent light shown at 505 is emitted from coherent light source 501. Light beam 505 is modulated by modulator 502 and the modulated light is shown at 506. The modulated light shown at 506 is dispersed by reflective device 503 such that the angle of the beam shown after dispersion at 507 is wider than the angle of the beam at 505 or 506. The beam shown at 506 is looked into by a viewer in order to view a holographic image. The beam is not projected onto a wall, screen or other surface.

In the present embodiment the coherent light source 501 is a semiconductor laser device. In alternative embodiments, a number of lasers are included so as to provide a colour space. For example, a red laser, a green laser and a blue laser may be provided.

The holographic image that is viewed by a viewer as described with reference to FIGS. 2, 3 and 4 is effectively an interference pattern. Phase modulator 502 alters the phase of waves of coherent light emitted from light source 501, such that the interference pattern produced by the light once it has been modulated provides a meaningful holographic image. Viewing aperture 108 in housing 504 allows light beam 507 to leave the device and allows a viewer to view the holographic image. In an alternative embodiment viewing aperture 108 is covered by a transparent layer to protect the equipment inside housing 504.

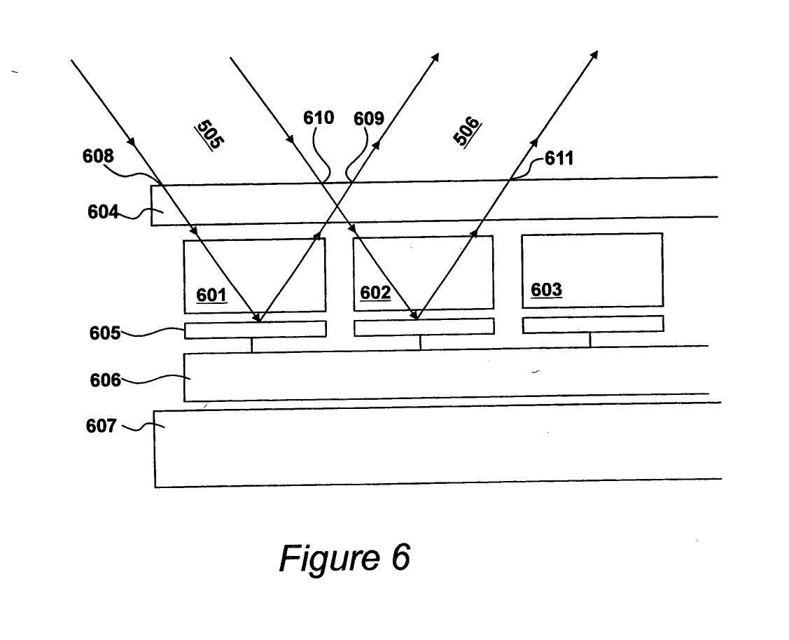

### FIG. 6

Detail of light modulating device 502 is shown in FIG. 6. In this example, the light modulating device takes the form of an array of phase responsive liquid crystals. Three crystals are shown in this diagram. A first crystal 601 is shown next to a second crystal 602 and a third crystal 603. In the present embodiment, a large array of liquid crystals is provided. For example, a square array of 2000×2000 liquid crystal devices could be used. A transparent layer is shown at 604 which allows light to pass through it and protect the array of liquid crystals.

Each liquid crystal has associated with it a reflective surface such as surface 605 shown for liquid crystal 601. Each of the array of crystals has the property that when a voltage is applied across it, the properties of the liquid crystal change. In this example, the property that changes is that the amount of phase delay introduced by the liquid crystal is altered. The degree of phase delay is dependent on the voltage level applied across the liquid crystal. The voltage that is applied to each liquid crystal can be altered individually. A silicon chip backplate is provided at 606 onto which the liquid crystals are mounted. Thus a liquid crystal on silicon (LCOS) apparatus is provided. A back plate is also provided at 607. A voltage can be applied between reflective layer 605 and transparent layer 604 in order to affect the properties of the liquid crystals. Silicon plate 606 transmits the voltages to the reflective plates.

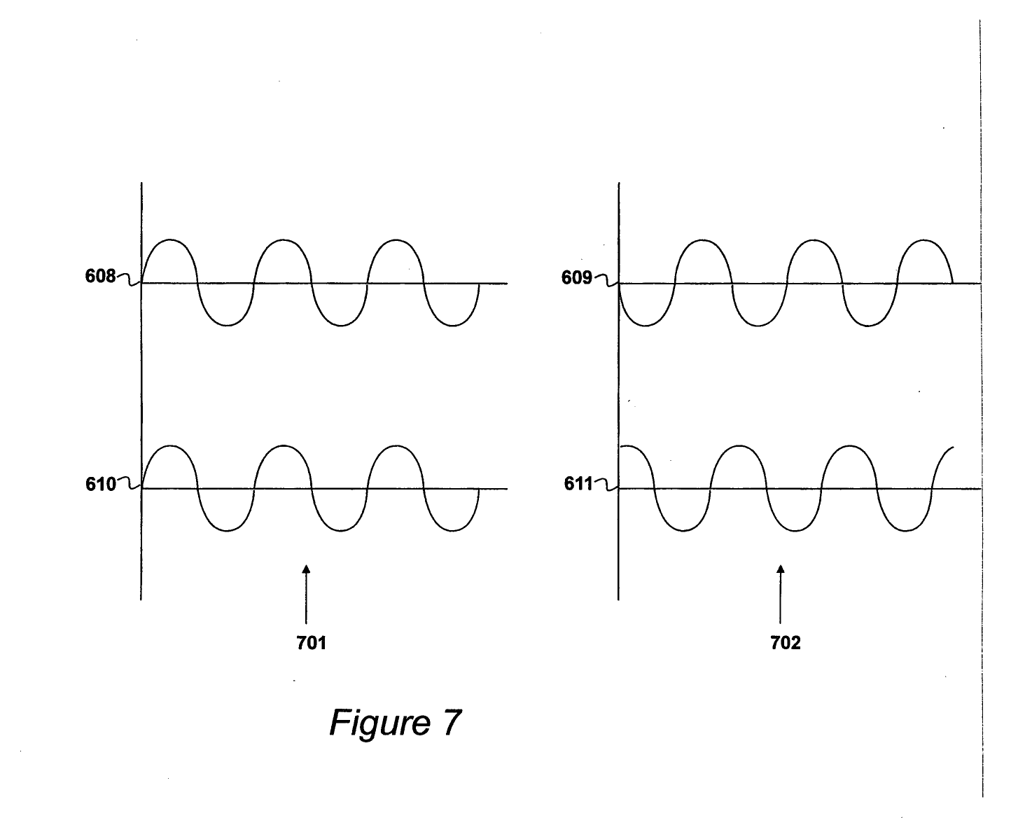

Light enters the apparatus of FIG. 6 at, in this example, point 608. The light passes through transparent layer 604, passes through liquid crystal 601 and reflects from reflective surface 605. The light then passes back through liquid crystal 601, out through transparent layer 604 and leaves the apparatus at point 609. In this example, a coherent light source such as a laser is used therefore at point 608 the light waves are all in phase. After passing through the liquid crystal 601 the light waves may or may not have had their phase altered depending upon the voltage applied to crystal 601. A second beam of light is seen entering the apparatus at point 610. The light entering the apparatus is in phase with the light entering at 608. This light passes through transparent layer 604, liquid crystal 602 reflects from the reflective back plate and leaves the apparatus at 611. At point 611 this second beam of light has had its phase modulated by a different degree from the first beam of light. This is because the two liquid crystals 601 and 602 have had different voltages placed across them. Thus, the beams of light leaving the apparatus at 609 and 611 are no longer in phase. A diagrammatic representation of this is provided in FIG. 7.

In an alternative embodiment, a piezo-electric crystal is also utilised in order to further alter the light. A piezo-electric crystal allows the liquid crystals to be moved by a tiny amount, this can be used to apply dither which reduces the appearance of noise and/or speckle, or for other applications.

### FIG. 7

An example of the differing phase delays is shown in FIG. 7. The first light beam shown entering the apparatus at 608 and the second light beam entering the apparatus at 610 are seen to be in phase at 701. After passing through liquid crystals 601 and 602 respectively it can be seen at 702 that the beams leaving the apparatus at 609 and 611 have been modulated to alter their phase to different degrees.

When the apparatus shown in FIG. 6 is scaled up to have a large number of liquid crystals, the light which is emitted (after having its phase altered) produces an interference pattern. This pattern forms a hologram.

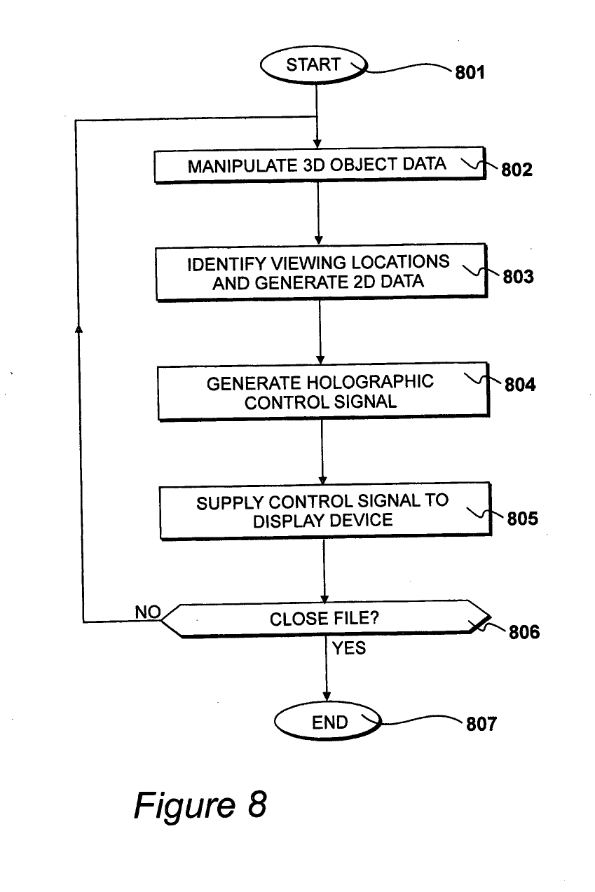

### FIG. 8

An overview of procedures according to an embodiment of the present invention is shown in FIG. 8. Procedures start at 801, and at 802 three-dimensional object data is manipulated. This is done in a conventional software environment such as a CAD system or any other system which has three-dimensional object data that defines positions in a three-dimensional world space.

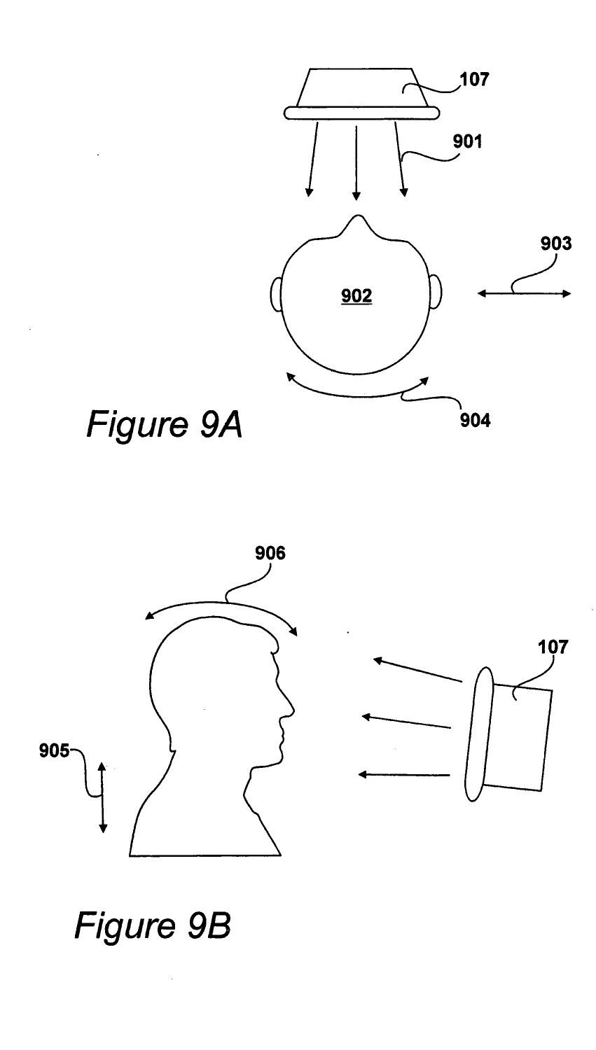

At step 803, viewing positions are identified. This procedure is further described with reference to FIG. 9. A plurality of notional viewing locations are identified that are compatible with notional eye-viewable positions. For each notional viewing location, which is a place where a user could conceivably wish to view from, a set of two-dimensional data is produced. Thus effectively the three-dimensional data is rendered in a series of two-dimensional images, one for each notional viewing location which is compatible with a notional eye-viewable position. In this example, the data produced is two-dimensional image data that represents intensity values, and they are produced for a plurality of colours. In this example, two or more closely similar colours are produced such that when displayed alternately (in time sequence) the colours average the effect of laser speckle.

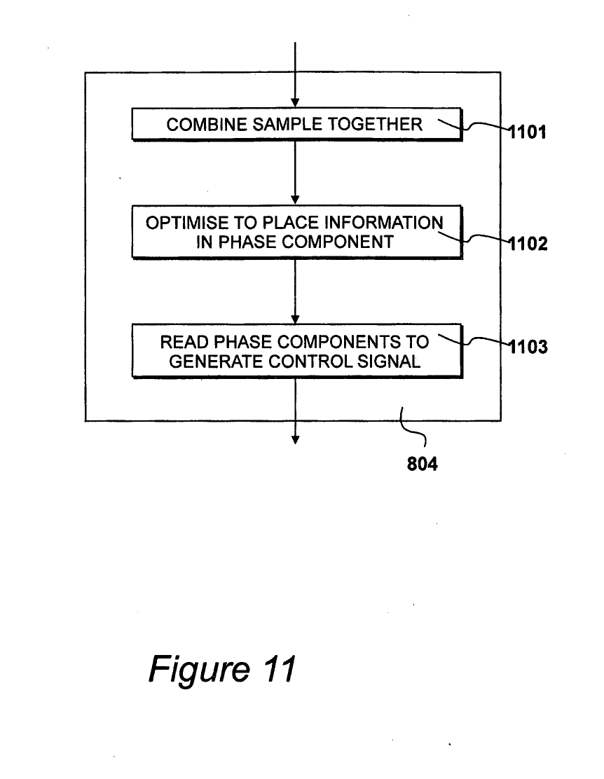

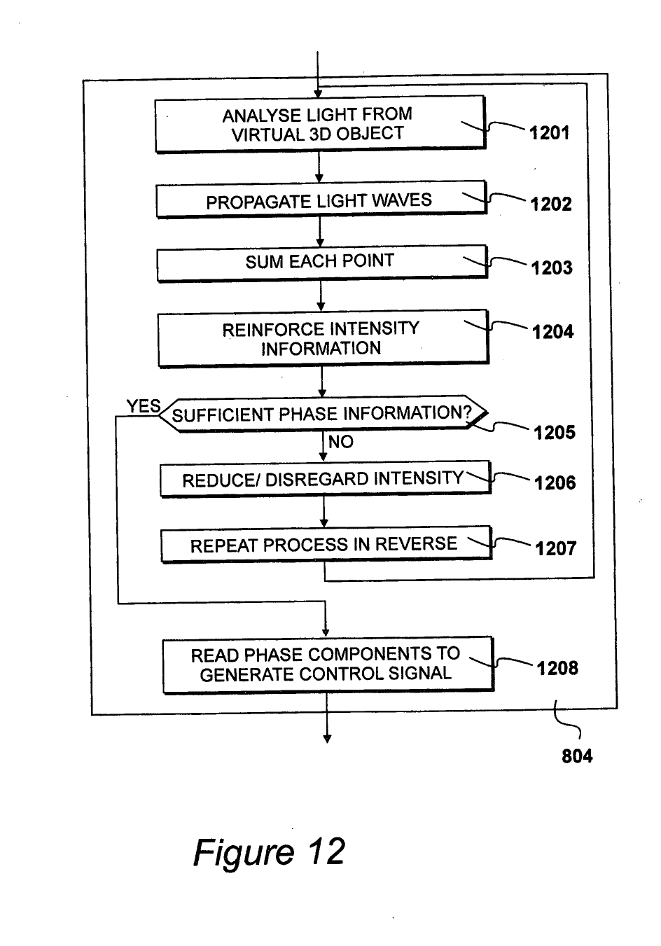

At step 804 a holographic control signal is generated. This step is further described with reference to FIGS. 11 and 12. The signal is generated by processing the two-dimensional image data representing parts of the object. The holographic control signal takes the form of phase-emphasised holographic data. This control signal is supplied to the display device 107 at step 805. Display device 107 then displays an image that is viewable at locations compatible with the eye-viewable locations. This is implemented as described with reference to FIGS. 6 and 7. A coherent light source has its phase modulated and the coherent light source is directed to a viewer.

At step 806 a question is asked as to whether the file has been closed. If this question is answered in the affirmative then procedures end at step 807. If the question asked at step 806 is answered in the negative indicating that the file has not been closed then procedures loop back to step 802 whereby the three-dimensional object data can be manipulated and the updated version can be displayed as a holographic image. The manipulation may, for example, take the form of reading the object data, creating the object data, moving an object or applying colour, texture or shading etc.

### FIG. 9

A representation of the step of identifying a plurality of notional viewing locations that are compatible with notional eye-viewable positions is shown in FIG. 9. Device 107 is shown in both FIGS. 9a and 9b. In FIG. 9a, device 107 is shown emitting light as represented by arrows at 901. The location of a viewer is represented at 902. A first direction of movement is shown by arrow 903 (side to side). A viewer viewing the holographic image tends to perform the largest degree of movement in directions as shown by arrow 903. A further arrow 904 identifies a rotation of the head thus moving the location of the eyes.

In FIG. 9b, further directions of movement are illustrated. Arrow 905 indicates movement in the vertical plane. This movement is generally of a lesser degree to movement in the horizontal plane as represented by arrow 903. A further direction of movement represented by arrow 906 is that of tilting the head forwards and backwards.

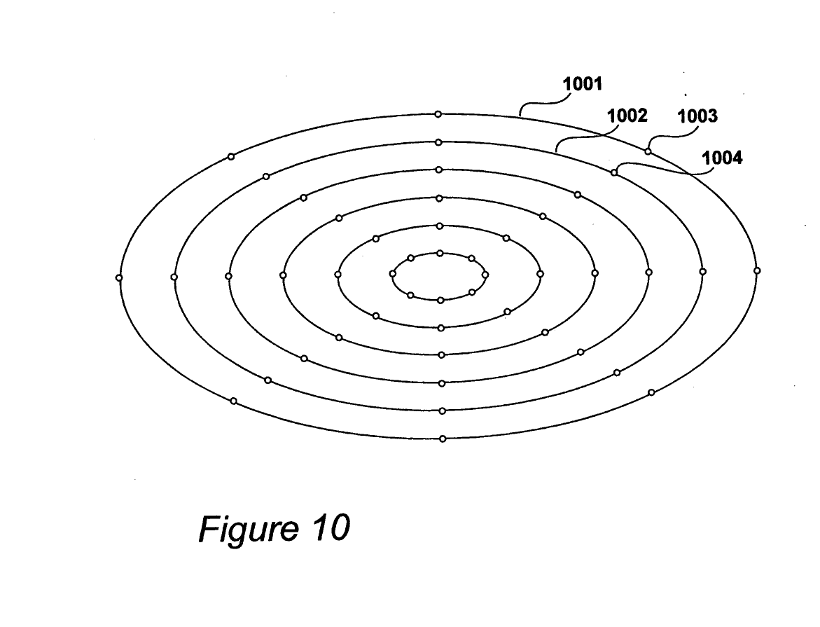

Thus the movements described in FIG. 9a results in a horizontal change of position and the movements described in FIG. 9b result in a vertical change in position. As part of the step of identifying a plurality of notional viewing locations, a three-dimensional surface can be defined which represents the likely locations from which an image is to be viewed. In the present example, this surface is substantially elliptical (spheroid). Thus the shape resembles that of a rugby ball. The viewer is likely to wish to view the image from a position within this spheroid. The spheroid can be divided in to concentric ellipses that present greater definition horizontally compared to the vertical definition. Thus, rather than producing two-dimensional image for every possible location within the spheroid, the number of images to be produced is produced by effectively sampling the viewing space. This is further described with reference to FIG. 10.

### FIG. 10

A representation of sampling of the viewing space is shown in FIG. 10. This is a two-dimensional representation but it should be appreciated that the viewing space is a three-dimensional shape. A series of spheroids are represented by ellipses such as ellipse 1001 and ellipse 1002. A number of locations are identified on the surface of each spheroid and this is represented by nodes such as node 1003 which is on ellipse 1001 and node 1004 which is on ellipse 1002. The nodes represent viewing locations on the three-dimensional viewing surface. Thus, a plurality of notional concentric ellipses are provided that present greater definition horizontally compared to the vertical definition.

The number of notional viewing locations identified depends upon the configuration of the system. In the present embodiment, a degree of optimisation is undertaken such that number of viewing locations identified is the minimum number required in order to produce a satisfactory holographic image. An algorithm may be provided to calculate how many viewing locations are required. The number of notional viewing locations will vary dependent upon the content of the holographic image. For example, an image containing a greater degree of detail will require a larger number of notional viewing locations in order to represent the detail. In addition, dependent upon the application and use of the holographic image some applications may require a greater degree of detail than others.

### FIG. 11

An example of procedures taking place as part of step 804 at which a holographic control signal is generated are shown in FIG. 11. This is a first example of how procedures can be carried out. A second example is shown in FIG. 12.

At step 1101 the samples which are sets of two-dimensional data generated at step 803 are combined. Thus, all the two-dimensional data representing two-dimensional views from notional viewing locations are combined together to form one large set of data. This combination takes the form of a mathematical convolution operation. At step 1102, this data set is optimised so that information is placed into the phase component. A method for performing this is using an iterative process that increases information content within phase data components at the expense of information content within the intensity data. An algorithm suitable for this task is the Gerchberg-Saxton algorithm. A possible optimisation of this algorithm is to start with a random value for phase.

Once information has been moved into the phase component at step 1102, the phase components can be read at 1103 in order to generate a control signal. This signal is supplied to the Liquid Crystal on Silicon (LCOS) device which modulates light as described with reference to FIG. 6.

### FIG. 12

An alternative sequence of steps in order to fulfil step 804 at which a holographic control signal is generated is shown in FIG. 12.

At 1201 the light reflected from the virtual three-dimensional object is analysed. Illumination of the object is simulated with plane waves of coherent light. The reflected light from a plurality of points on the surface of the object is calculated. At step 1202 the light waves are propagated forwards to a plane in space where the LCoS device will be situated in relation to the object. Summing each point on the surface of the object takes place at step 1203. This process is carried out in the present example by Fourier mathematics. The surface of the object is sliced into layers which in a first example can be planer and parallel to the plane of the LCoS device or in an alternative example a polar co-ordinate system can be used which is centred on the middle of the object. Layers move outwards from the centre dividing the object surface. Light from each layer is propagated to the next layer. The next layer's contribution is added and then the result is propagated to the next layer etc. This produces better distribution of information.

Each propagation which takes place involves a Furrier transform and complex scaling. Phase and intensity components are both propagated and in the current example random phase is used in forward propagation.

At step 1204 the intensity information is reinforced with object information on arrival back at the object centre.

A question is asked at step 1205 as to whether sufficient phase information has accumulated at the LCoS plane. If this question is answered in the affirmative then control passes to step 1208. If the question asked at step 1205 is answered in the negative identifying that sufficient phase information has not been accumulated then control passes to step 1206. At step 1206 the intensity information is either reduced or discarded, depending upon the system configuration. At step 1207 the process is repeated in reverse after constraining intensity information. This occurs on arrival at the plane at which the LCoS device is situated. Control then passes back to step 1201.

At step 1208 the phase components are read in order to generate a control signal which is fed to the LCoS device as described with reference to FIG. 6 in order to modulate light.

The embodiment described herein relates to computer generated data such as CAD data. Many alternative applications of this technology can be utilised. Any of the applications described herein can use a network connection and receive object data in response to a request received from a browser.

A first example is for medical imaging. Medical images such as holographic projections of living body organs can be displayed and a three-dimensional depiction of these can assist clinicians in their diagnosis and treatment. Such a holographic image can be generated from three-dimensional object data which is derived from a scanning procedure such as a nuclear magnetic resonance (NMR) scan, a plurality of tomographs or any other method of producing three-dimensional object data.

A further application is in three-dimensional metrics. Empirical input can be provided from real world data and dimensions can be calculated and displayed as holographic images.

A further application is in computer games. Given the ability of the holographic image to be updated in real time, a three-dimensional computer gaming program can be produced. Furthermore, the apparatus can be utilised in the creation of computer games, for example in order to test the three-dimensional layout of objects within a game. The development of computer gaming tools or creation of gaming characters can also use the holographic imaging display technique.

A further application is in retail. Object data represents an item for sale that can be displayed as a holographic image. An example of a specific application for this is that an item is a clothing item and it appears modelled in three-dimensional space as a holographic image. This example can be further developed by including an avatar that resembles a viewer and models a clothing item which the viewer is considering purchasing. Thus, the clothing item can be seen in three-dimensions and a viewer can form an opinion of how the clothing item will look once they have purchased and are wearing it. This application may include receiving the object data from a network connection in response to a request received from a browser capable of sending and receiving signals across a network.

1. A method of displaying a holographic image, comprising the steps of:
manipulating three-dimensional object data that defines positions in a three-dimensional world space;
identifying a plurality of notional viewing locations that are compatible with notional eye-viewable positions;
producing a two-dimensional image data set from said three-dimensional object data for each identified viewing location;
processing said two-dimensional image data sets to produce phase-emphasised holographic data;
modulating the phase of a coherent light source; and
directing said coherent light to a viewer so as to be viewable at locations compatible with said eye-viewable locations.

2. A method according to claim 1, wherein said object data is computer generated data.

3. A method according to claim 2, wherein said computer generated object data is generated by a computer aided design (CAD) program, a medical imaging program, a three dimensional metrics program, a computer gaming program, a program for the creation of computer games, a program for the development of computer gaming tools or a program for the creation of gaming characters.

4. A method according to claim 1, wherein said object data is received from a network connection in response to a request received from a browser.

5. A method according to claim 4, wherein said object data represents an item for sale.

6. A method according to claim 5, wherein said item is a clothing item and said item is modelled in the three-dimensional space.

7. A method according to claim 6, wherein said item is modelled by an avatar that resembles a viewer.

8. A method according to claim 7, wherein said avatar appears as if viewed in a mirror.

9. A method according to claim 1, wherein said manipulating step includes reading the object data, creating the object data; moving an object defined by said object data or applying colour, texture or shading to the object data.

10. A method according to claim 1, wherein said identifying step includes defining a three dimensional surface, wherein said identifying step identifies said plurality of notional viewing locations on said surface.

11. A method according to claim 10, wherein said surface is substantially elliptical (spheroid).

12. A method according to claim 11, wherein said notional viewing locations are located at positions identified by notional concentric ellipses that present greater definition horizontally compared to the vertical definition.

13. A method according to claim 12, wherein colour components are produced in two or more of closely similar colours such that when displayed alternately in time said closely similar colours average the effect of laser speckle.

14. A method according to claim 1, wherein said producing step produces two-dimensional image data that represents phase data.

15. A method according to claim 14, wherein said phase data is produced by calculating distances from viewing positions to an object defined by said object data.

16. A method according to claim 1, wherein said processing step includes steps of convolving a plurality of data sets and performing a transform upon the result of said convolution.

17. A method according to claim 1, wherein said processing step includes steps of performing a transform upon each of said data sets and then combining said transformed data sets.

18. A method according to claim 1, wherein said phase emphasised holographic data is produced by an iterative process that increases information content within phase data components at the expense of information content within the intensity data.

19. A method according to claim 1, wherein said modulating step is performed in response to said holographic data being applied to an array of phase responsive liquid crystals.

20. A method according to claim 19, wherein said modulating step is enhanced in response to supplying additional signals to a piezo-electric crystal.

21. A method according to claim 1, wherein a further modulation or dither is applied to the coherent light source so as to reduce the presence of speckle and/or to enhance the definition of colour depth.

22. A method according to claim 1, wherein revised holographic data is continually produced so as to allow movement of the three dimensional image.

23. A method according to claim 22, wherein said revisions occur substantially at video frame-rate (in real time) to produce naturalistic movement.

24. A method according to claim 23, wherein video-rate holographic data is produced in real-time or is pre-calculated and read from storage.

25. A method according to claim 1, wherein the production of said phase-emphasised holographic data occurs by simulation of propagation of light from a virtual illuminated object.

26. A method according to claim 25, wherein said propagation is optimised to achieve maximum phase information.

27. Apparatus for displaying a holographic image, comprising a display device having a viewing aperture,
a source of coherent light,
a phase modulator for modulating said coherent light in response to a control signal, and
a processing device for producing said control signal, wherein said processing device is configured to:
manipulate three-dimensional image data;
identify a plurality of notional viewing locations;
produce two-dimensional image data sets; and
process said data sets to produce said control signal taking the form of a phase-emphasised holographic control signal.

28. Apparatus according to claim 27, wherein said source of coherent light is an semiconductor laser device.

29. Apparatus according to claim 28, wherein a plurality of lasers are included to provide a colour-space.

30. A computer aided design system including apparatus for displaying holographic images according to claim 27.

31. A system for displaying medical images (holographic projections of living body organs) including apparatus for displaying holographic images according to claim 27.

32. A system according to claim 31, wherein said three dimensional object data is derived from a scanning procedure.

33. A system according to claim 32, wherein said scanning process uses nuclear magnetic resonance.

34. A system according to claim 32, wherein said three dimensional data is derived from a plurality of tomographs.

35. A three dimensional metrics system for calculating and displaying dimensions in response to empirical input, including apparatus for displaying holographic data according to claim 27.

36. A system for creating tools for computer games, the development of computer games or the playing of computer games, including apparatus for displaying holographic data according to claim 27.
